(19) United States
(12) Patent Application Publication
(10) Pub. No.: US 2026/0064486 A1
(43) Pub. Date: Mar. 5, 2026

(54) COMPUTER-READABLE RECORDING MEDIUM HAVING STORED THEREIN INFORMATION PROCESSING PROGRAM, METHOD FOR PROCESSING INFORMATION, AND INFORMATION PROCESSING DEVICE

(71) Applicant: Fujitsu Limited, Kawasaki-shi (JP)

(72) Inventors: Ryuichi KIYOTA, Fukuoka (JP); Hiroyuki KAWAI, Fukuoka (JP); Atsushi KISHIDA, Machida (JP)

(73) Assignee: Fujitsu Limited, Kawasaki-shi (JP)

(21) Appl. No.: 19/285,701

(22) Filed: Jul. 30, 2025

(30) Foreign Application Priority Data
Aug. 27, 2024 (JP) 2024-145439

(51) Int. Cl. G06F 9/50

(52) U.S. Cl. CPC G06F 9/505

(57) ABSTRACT

A computer-readable recording medium has stored therein a program for causing a computer to execute an information process including: obtaining an operating temperature and a processing load of each of a plurality of process executing devices; and migrating a process assigned to a first process executing device to a second process executing device, the first process executing device and the second process executing device being included in the plurality of process executing devices, the first process executing device having the operating temperature equal to or higher than a first given value and the processing load lower than a second given value, the second process executing device having the operating temperature lower than a third given value equal to or lower than the first given value.

### CROSS-REFERENCE TO RELATED APPLICATION

This application is based upon and claims the benefit of priority of the prior Japanese Patent application No. 2024-145439, filed on Aug. 27, 2024, the entire contents of which are incorporated herein by reference.

### FIELD

The embodiment discussed herein relates to a computer-readable recording medium having stored therein an information processing program, a method for processing information, and an information processing device.

### BACKGROUND

In recent years, situations where a large amount of data is processed at a high speed in analyzing process of big data or an inferring process in an Artificial Intelligence (AI) technique have been increased.

For the above, higher performance than Central Processing Units (CPUs) is expected to deal with a workload requiring enhanced performance of a data center or a server.

One of the approaches to computing at higher performance and more efficient than CPUs is a scheme using accelerator cards (ACCs), such as Graphics Processing Units (GPUs) and Field-Programmable Gate Array (FPGA), for example.

An ACC is an example of a process executing device that executes a process, and is a type of expansion-card that is additionally used in a computer such as server. An ACC is a card-shaped device complying with a Peripheral Component Interconnect express (PCIe), for example, and is installed in a PCIe slot or a PCIe expansion box of main body of the server. A PCIe expansion box is a device that expands (adds) PCIe slots and accommodates multiple ACCs, and is connected to the PCIe slot of the main body of the server via an adapter.

Pooling of ACCs has been developed in order to make efficient use of the resource of the ACCs and to further enhance the throughput of large-capacity data. The pooling of ACCs is a configuration that connects multiple PCIe extension boxes to a server to increase ACCs accommodated in a single server (hereinafter sometimes referred to as a “pooled configuration”), and is used to embody a configuration of, for example, Composable Disaggregated Infrastructure (CDI). Consequently, a computer can efficiently use multiple ACCs that are expanded and pooled, so that a large amount of data can be processed at high speed.

For example, related arts are disclosed in Japanese Laid-open Patent Publication No. 08-16531, and Japanese Laid-open Patent Publication No. 2004-126968.

### SUMMARY

According to an aspect of the embodiment, a non-transitory computer-readable recording medium has stored therein a program for causing a computer to execute an information process including: obtaining an operating temperature and a processing load of each of a plurality of process executing devices; and migrating a process assigned to a first process executing device to a second process executing device, the first process executing device and the second process executing device being included in the plurality of process executing devices, the first process executing device having the operating temperature equal to or higher than a first given value and the processing load lower than a second given value, the second process executing device having the operating temperature lower than a third given value equal to or lower than the first given value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a hardware configuration of a system according to one embodiment;

FIG. 2 is a block diagram illustrating an example of a hardware configuration of a server illustrated in FIG. 1;

FIG. 3 is a block diagram illustrating an example of a software configuration of the server of the one embodiment;

FIG. 4 is a diagram illustrating an example of obtaining an operating temperature and a processing load of an ACC;

FIG. 5 is a diagram illustrating an example of a method of determining a status of each ACC by a determining unit;

FIG. 6 is a diagram illustrating an example of a method of determining an ACC serving as a migration destination candidate by the determining unit;

FIG. 7 is a diagram illustrating an example of a method for migrating a process that an ACC is caused to execute by a setting unit;

FIG. 8 is a flow diagram illustrating an example of operation of the system of the one embodiment;

FIG. 9 is a diagram illustrating an example of suppressing heat concentration of multiple ACCs in the one embodiment; and

FIG. 10 is a block diagram illustrating an application example of the configuration of the system of FIG. 1.

### DESCRIPTION OF EMBODIMENTS

Increase in consumption energy accompanied by development of high-performance processors is increasing a heat generation amount in accordance with processing loads in the course of processing by the ACCs. When a single ACC is heated in a PCIe expanded box in a configuration in which multiple ACCs operate in close proximity, such as in a pooled configuration, ACCs located in the vicinity of the heating ACC, for example, ACCs arranged next to the heating ACC, may be affected by the heating ACC and the processing temperatures of the ACCs may rise.

As the above, multiple ACCs including the heating ACC may be heated to a high temperature in accordance with the processing load of the ACC, which may make it difficult to stably execute the process of the multiple ACCs having the increased temperature.

Hereinafter, an embodiment will now be described with reference to the accompanying drawings. However, the following embodiment is merely illustrative and is not intended to exclude the application of various modifications and techniques not explicitly described in the embodiment. For example, the present embodiment can be variously modified and implemented without departing from the scope thereof. Further, each of the drawings can include additional functions not illustrated therein to the elements illustrated in the drawing.

### (A) Example of Hardware Configuration

### (A-1) Example of Hardware Configuration of System

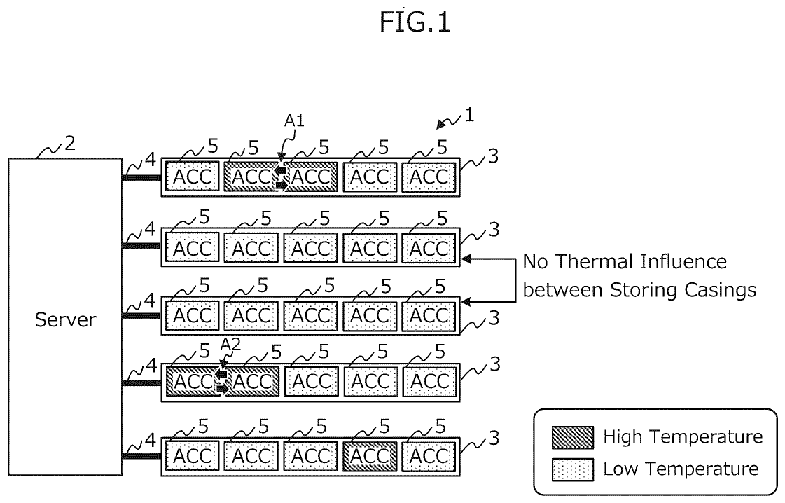

FIG. 1 is a diagram illustrating an example of a hardware configuration of a system 1 according to an example of one embodiment. As illustrated in FIG. 1, the system 1 may include a server 2, one or more (five in example of FIG. 1) storing casings 3, and interconnects 4.

The system 1 is an example of an information processing system that allocates resources in the storing casings 3 to the server 2 and causes the server 2 to execute processes using the resources. The system 1 may provide a service as a CDI to a user, such as a non-illustrated computer (hereinafter also referred to as “user terminal”) that accesses the system 1 via a network such as the Internet.

The server 2 is an example of an information processing device or a computer. The server 2 may include at least a CPU as a hardware resource. The CPU is one example of a processor, and executes various pieces of software including an application.

The server 2 may be a general-purpose computer, or may be a computer that omits at least a part of the hardware resources constituting the computer on the premise that the server 2 uses resources in a non-illustrated resource pool including the storing casings 3.

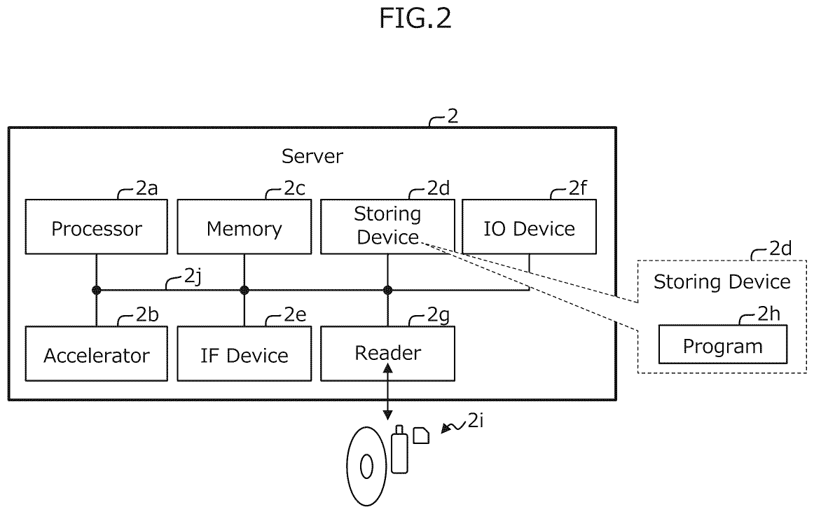

The one embodiment assumes that the server 2 is a general-purpose computer that includes at least hardware resources that enables the server 2 to solely operate in addition to the CPU. Hereinafter, a hardware resource is sometimes simply referred to as hardware (HW) or a resource. The HW configuration of the server 2 will be described below with reference to FIG. 2.

Each of the storing casings 3 is an example of a casing capable of accommodating multiple (two or more) ACCs 5 in a line, and stores a given number (e.g., five) of ACCs 5 in the example of FIG. 1. Each storing casing 3 may include, for example, a given number (e.g., five) of slots that can removably place (insert) ACCs 5 therein and that are arranged in a line, and may communicably connect the multiple ACCs 5 to the server 2 via the slots and the interconnect 4. The one embodiment will be described on an assumption that the slots are compatible with the PCIe standard that the ACCs 5 comply with, but the standard that the slots follow is not limited to this and may alternatively correspond to various communication standards that the ACCs 5 follow.

If the ACCs 5 comply with the PCIe standard, each storing casing 3 may be referred to as a PCIe extension box. In this case, each storing casing 3 may be connected to the PCIe slot of the main body of the server 2 via the corresponding interconnect 4, whereby the number of ACCs 5 that the server 2 can use as PCIe devices can be increased (expanded).

In the one embodiment, the system 1 is assumed to include five storing casings 3, but the number of storing casings 3 is not limited to five and may be at least one according to the demand for expansion of the function of the server 2. For the sake of convenience, the one embodiment assumes that the arrangement of the slots (in other words, the ACCs 5) is one-dimensional arrangement, but the arrangement is not limited to this. Alternatively, the arrangement of the slots in each storing casing 3 may be, for example, a two-dimensional arrangement in which the slots are arranged in multiple lines on a plane, or a three-dimensional arrangement.

The interconnect 4 is a network (high-speed interconnect) that communicably connects the server 2 and the storing casing 3 accommodating the ACCs 5 to each other according to information that associates each ACC 5 with a process assigned (allocated) to the ACC 5. The interconnect 4 may be, for example, a network conforming to a high-speed bus architecture such as PCIe, Ethernet®, and Myrinet.

The ACC 5 is an example of a process executing device, and executes a process requested (e.g., offloaded) by the server 2 and transmits the result of the execution to the server 2. Examples of the ACC 5 are various arithmetic processing devices such as a GPU, an FPGA, an Accelerated Processing Unit (APU), a Digital Signal Processor (DSP), and an Application Specific Integrated Circuit (ASIC). For example, the ACC 5 may be used as an accelerator (AI accelerator) that executes, for example, an analyzing process of big data and an inferring process of the AI technique by the above arithmetic processing. The ACC 5 may be, for example, an expansion card additionally used in the server 2. In the one embodiment, the ACC 5 is assumed to comply with the PCIe standard, but is not limited thereto. Alternatively, the ACC 5 may comply with another communication protocol such as NVLink®.

### (A-2) Example of Hardware Configuration of Server

The function of a server 2 of the first embodiment may be achieved by one computer or by two or more computers. Further, at least a part of the functions of the server 2 may be implemented using Hardware (HW) resources and Network (NW) resources provided by cloud environment.

FIG. 2 is a block diagram schematically illustrating an example of a hardware (HW) configuration of the server 2 illustrated in FIG. 1. If multiple computers are used as the HW resources for embodying the functions of the server 2, each of the computers may include the HW configuration illustrated in FIG. 2.

As illustrated in FIG. 2, the server 2 may illustratively include, as the HW configuration, a processor 2a, an accelerator 2b, a memory 2c, a storing device 2d, an Interface (IF) device 2e, an Input/Output (IO) device 2f, and a reader 2g.

The processor 2a is an example of an arithmetic processing device that performs various types of control and calculations. The processor 2a may be mutually communicably connected to each of the blocks in the server 2 via a bus 2j. The processor 2a may be a multi-processor including multiple processors or a multi-core processor including multiple processor cores, or may have a structure including two or more multi-core processors.

The processor 2a may be any one of integrated circuits (ICs) such as CPUs, Micro Processing Units (MPUs), APUs, DSPs, ASICs, and FPGAs, or combinations of two or more of these ICs.

The accelerator 2b is an arithmetic processing device that executes AI tasks such as a machine learning process and an inferring process using a machine learning mode, and may be referred to as an AI accelerator. The accelerator 2b may have a configuration serving as a graphic processing device (graphic accelerator) that controls screen displaying on the 10 device 2f (e.g., output device such as a monitor). The ACC 5 illustrated in FIG. 1 is an example of the accelerator 2b. For example, the accelerator 2b may be mounted on the server 2, may be connected to the server 2 via the interconnect 4 and the storing casing 3 like the ACC 5, or have the both configurations. Examples of the accelerator 2b are various ICs such as GPUs, APUs, DSPs, ASICs, and FPGAs.

The memory 2c stores information such as various data, programs, and the like. An example of the memory 2c is one of a volatile memory such as a Dynamic Random Access Memory (DRAM) and a non-volatile memory such as a persistent Memory (PM) or the both.

The storing device 2d stores information such as various data, programs, and the like. Examples of the storing device 2d may be various storing devices including a magnetic disk device such as a Hard Disk Drive (HDD), a semiconductor drive device such as a Solid State Drive (SSD), a nonvolatile memory, and the like. The non-volatile memory may be, for example, a flash memory, a Storage Class Memory (SCM), a Read Only Memory (ROM), and the like.

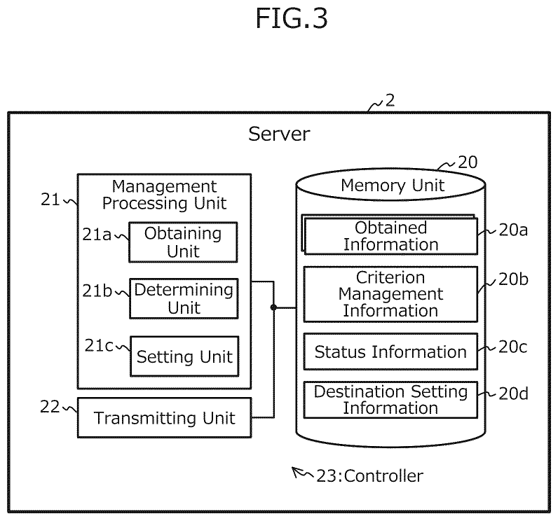

The storing device 2d may store a program 2h (information processing program) that implements all or a part of various functions of the server 2. For example, the processor 2a of the server 2 may achieve the function of a controller 23 to be detailed below (see FIG. 3) of the server 2 by expanding the program 2h stored in the storing device 2d on the memory 2c and executing the expanded program 2h.

The IF device 2e is an example of a communication IF that controls the connection and communication between the server 2 and another computer. For example, the IF device 2e may include an applying adapter conforming to a communication standard of the interconnect 4 such as PCIe, Ethernet®, InfiniBand or Myrinet. The applying adapter may be compatible with either or both of wireless and wired communication schemes. Furthermore, the applying adaptor may be compatible with optical communication such as Fibre Channel (FC).

For example, the server 2 may be communicably connected to each of the multiple ACCs 5 in the storing casings 3, via the IF device 2e, the interconnects 4, and the storing casings 3. Furthermore, the program 2h may be downloaded from the interconnects 4 or a non-illustrated network to the server 2 through the communication IF device 2e and be stored in the storing device 2d.

The 10 device 2f may include one or both of an input device and an output device. Examples of the input device include a keyboard and a mouse. Examples of the output device include a monitor, a projector, and a printer. The 10 device 2f may include, for example, a touch panel that integrates an input device and an output device with each other. The output device may be connected to the accelerator 2b.

The reader 2g is an example of a reader that reads information of data and programs recorded on a recording medium 2i. The reader 2g may include a connecting terminal or device to which the recording medium 2i may be connected or inserted. Examples of the reader 2g include an applying adapter conforming to, for example, a Universal Serial Bus (USB), a drive apparatus that accesses a recording disk, and a card reader that accesses a flash memory such as an SD card. The program 2h may be stored in the recording medium 2i. The reader 2g may read the program 2h from the recording medium 2i and store the read program 2h into the storing device 2d.

Examples of the recording medium 2i illustratively include a non-transitory computer-readable recording medium such as a magnetic/optical disk, and a flash memory. Examples of the magnetic/optical disk include a flexible disk, a Compact Disc (CD), a Digital Versatile Disc (DVD), a Blu-ray disk, and a Holographic Versatile Disc (HVD). Examples of the flash memory include a semiconductor memory such as a USB memory and an SD card.

The HW configuration of the server 2 described above is exemplary. Accordingly, the server 2 may appropriately undergo increase or decrease of the HW devices (e.g., addition or deletion of arbitrary blocks), division, integration in an arbitrary combination, or addition or deletion of the bus.

### (B) Example of Software Configuration

The multiple (25 in the example of FIG. 1) ACCs 5 may be managed as a resource pool in the system 1. For example, the server 2 may issue a request for executing a process to multiple pooled ACCs 5 (having a pooled configuration). If the multiple ACCs 5 are arranged in lines each accommodating a given number of ACCs 5 or less like the pooled configuration of the ACCs 5, which is exemplified a case where each storing casing 3 accommodates multiple ACCs 5, the multiple ACCs 5 are arranged close to each other. With this configuration, increasing the number of ACCs 5 in each storing casing 3 lowers the cooling effect of each of the ACCs 5. In such an arrangement, if the processing load on one ACC 5 in a storing casing 3 increases and the ACC 5 generates heat, ACCs 5 close to the heating ACC 5, which are exemplified by ACCs 5 next to the heating the ACC 5, further lower their cooling effect by being influence by the heating ACC 5 and may raise their operating temperature.

In FIG. 1, a block of a high-temperature ACC 5 is illustrated in an oblique-line pattern, and a block of a low-temperature ACC 5 is illustrated in a dot pattern. As indicated by the reference signs A1 and A2 in FIG. 1, if ACCs 5 next to each other both have high temperature, the both ACCs 5 have difficulty in heat dissipation due to lowering of the cooling effect and may have difficulty in stably executing processes. In this circumstance, the high-temperature ACC 5 may be further heated. ACCs 5 stored in the different storing casings 3 are less likely to be influenced by heating of the ACC 5 in another storing casing 3 although depending on the positional relationship between the intake and exhaust ports of the respective storing casings 3. The following description assumes that ACCs 5 stored in different storing casings 3 are not influenced by heating generated by the other (counterpart) ACC 5.

The server 2 may perform control that enables the multiple ACCs 5 to stably execute the their process (control that enhances the stability of the multiple ACCs 5). Hereinafter, description will now be made in relation to an example of the software configuration of the server 2.

FIG. 3 is a block diagram illustrating an example of the software configuration of the server 2 according to the one embodiment. As illustrated in FIG. 3, the server 2 may illustratively include a memory unit 20, a management processing unit 21, and a transmitting unit 22. The management processing unit 21 and the transmitting unit 22 are example of a controller 23.

The memory unit 20 is an example of a storing region, and stores various types of data that the server 2 uses. The memory unit 20 may be implemented by, for example, a storing region that one or the both of the memory 2c and the storing device 2d (see FIG. 2) of the server 2.

As illustrated in FIG. 3, the memory unit 20 may illustratively be capable of storing obtained information 20a for each ACC 5, criterion management information 20b, status information 20c, and destination setting information 20d. Hereinafter, each of the information 20a to 20d is represented in a table format, but the format is not limited thereto. The information 20a to 20d may be in various data format such as a Database (DB) or an array (an arrangement).

The obtained information 20a is an example of information related to each ACC 5, and may be obtained from the ACC 5 by an obtaining unit 21a of the management processing unit 21 to be detailed below. The obtained information 20a may include, for example, one or the both of the operating temperature and the processing load of each ACC 5.

The criterion management information 20b is an example of information that manages a determination criterion (a determination condition). The criterion management information 20b may include, for example, a temperature threshold (first temperature threshold) serving as an example of a first given value and a processing load threshold serving as an example of a second given value. The first and second given values are used to determine the status of each ACC 5. Further, the criterion management information 20b may include a second temperature threshold for determining, when a process assigned to a certain ACC 5 (i.e., a process executed by the certain ACC 5) is to be migrated to another ACC 5, whether or not the another ACC 5 is a proper migration destination. The second temperature threshold is an example of a third given value. The first temperature threshold, the processing load threshold, and the second temperature threshold may be set in advance by a user.

The status information 20c is an example of information indicating the status of an ACC 5 and may be information indicating the status of each ACC 5 determined on the basis of the obtained information 20a and the criterion management information 20b. The status information 20c may store the status of each of the multiple ACCs 5 in association with the respective positions of the ACCs 5. The position of each of the multiple ACCs 5 may be indicated, for example, by a coordinate format.

The destination setting information 20d is an example of information that manages assignment (allocation) of multiple processes to multiple process executing devices, and may be information indicating the type of a process that the server 2 causes an ACC 5 to execute and which one of the multiple ACCs 5 is to execute the process. The destination setting information 20d may be stored in association with the position of each of the multiple ACCs 5, such as the coordinates of the multiple ACCs 5, and may be updated by the setting unit 21c to be detailed below when the assignment of a process to an ACC 5 is changed by the setting unit 21c.

The management processing unit 21 illustratively includes the obtaining unit 21a, the determining unit 21b, and the setting unit 21c, and manages the multiple ACCs 5. The management processing unit 21 may carry out communication between the server 2 and each ACC 5 via the IF device 2e (see FIG. 2) and the interconnects 4 (see FIG. 1).

The obtaining unit 21a obtains the obtained information 20a from each of ACC 5. The obtaining unit 21a may obtain the obtained information 20a of each of the multiple ACCs 5, such as the operating temperature and the processing load of each ACC 5, at given intervals (e.g., every one second) and store the obtained information 20a into the memory unit 20. For example, the obtaining unit 21a may store, as obtained information 20a, the operating temperature and the processing load of each of the multiple ACCs 5 into the memory unit 20 in association with the position, such as a coordinate, of each of the multiple ACCs 5.

Examples of the operating temperature include a temperature (° C.) of at least one of the processor, the memory, and the network IF of each ACC 5 measured by, for example, a temperature sensor. Examples of the processing load include a usage rate (%) of at least one of the processor, the memory, and the network IF of each ACC 5.

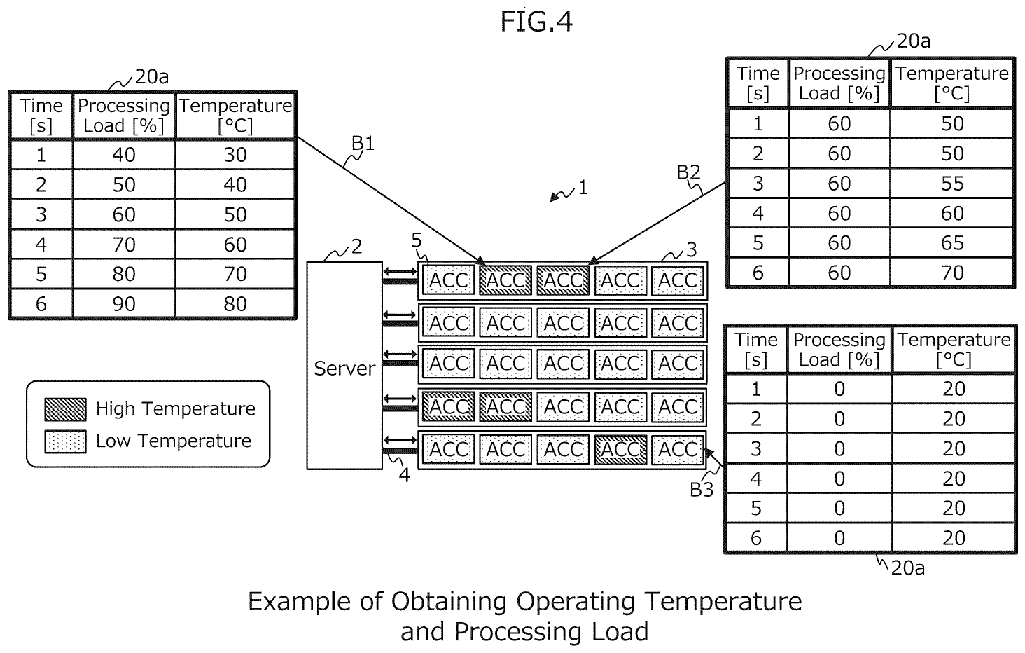

FIG. 4 is a diagram illustrating an example of obtaining of the operating temperature and the processing load of an ACC 5. FIG. 4 illustrates an example in which the obtaining unit 21a obtains the operating temperature and the processing load of each ACC 5 via the corresponding interconnect 4 at given intervals (in the example of FIG. 4, every one second).

For example, the reference sign B1 of FIG. 4 indicates the obtained information 20a of the second ACC 5 from the left end in the storing casing 3 on the top row of the drawing. To the obtained information 20a, an entry is added at given intervals, for example, every one second (s), and in the reference sign B1 of FIG. 4, a processing load of 90% and a temperature of 80° C. are set when 6 second has elapsed (time point 6s) from the start. Similarly, in the center ACC 5 in the storing casing 3 on the top row of the drawing indicated by the reference sign B2 and the first ACC from the right end in the storing casing 3 of the fifth row from the top indicated by the reference sign B3, the processing load and the temperature of every one second are set in the respective obtained information 20a.

An example of a method of obtaining the obtained information 20a is polling. In polling, the obtaining unit 21a may periodically send a request for obtaining information of a temperature and a processing load to each ACC 5 and receive a response from the ACC 5.

Alternatively, the obtaining unit 21a may obtain, for example, calculate, the processing load of each ACC 5 on the basis of the information related to the process to be executed by the ACC 5 and the information related to the performance (specifications) of the ACC 5. The information related to a process may include, for example, the content and the volume of the process, and if the content of the process is an inferring process in an AI task related to an image processing, the volume of the process may be the number of images and the image sizes, for example. The obtaining unit 21a may calculate the information related to the process by obtaining a data transfer volume (data volume) transmitted to each ACC 5 by using, for example, a system monitoring tool. The obtaining unit 21a may calculate the processing load of each ACC 5 by comparing the information related to the process with information related to the performance of the ACC 5 that is to execute the process, such as the processing performance of the processor, the capacity of the memory, and the bandwidths of the memory and the network IF.

As illustrated in FIG. 4, the operating temperature of an ACC 5 increases as the processing load of the ACC 5 rises (see, for example, a chronological change of the reference sign B1 in FIG. 4). In the multiple ACCs 5 stored in a storing casing 3, when one ACC 5 has a high temperature, the ACC 5 (neighboring ACC 5) next to the high-temperature ACC 5 may degrade its cooling effect due to a heat transfer from the high-temperature ACC 5. For this reason, the neighboring ACC 5 may be heated to a higher temperature than the operating temperature corresponding to its own processing load (refer to the entries of the time 3s to 6s of the reference sign B2 in FIG. 4). On the other hand, since an ACC 5 which has a low processing load and which has no high-temperature neighboring ACC 5 (which means that the ACC 5 is not next to a high-temperature ACC 5) has an operating temperature according to its own processing load and is therefore not heated, the ACC 5 keeps a low operating temperature (see the reference sign B3 in FIG. 4).

The determining unit 21b determines the status of each ACC 5 based on the obtained information 20a and the criterion management information 20b obtained by the obtaining unit 21a. The determining unit 21b may determine the status of each ACC 5 and classify the ACC 5 into one of the following types.
Type A: ACC 5 having an operating temperature equal to or higher than the temperature threshold and a processing load equal to or higher than the processing load threshold.
Type B: ACC 5 having an operating temperature equal to or higher than the temperature threshold and a processing load lower than the processing load threshold.
Type C: ACC 5 having an operating temperature lower than the temperature threshold and a processing load lower than the processing load threshold.

The type C may further include an ACC 5 having an operating temperature lower than the temperature threshold and a processing load equal to or higher than the processing load threshold. In this case, the determining unit 21b may classify an ACC 5 having an operating temperature lower than the temperature threshold into the type C.

The determining unit 21b may store, as the status information 20c, the result of the classification into the memory unit 20 as the status information 20c in association with the respective positions of the multiple ACCs 5 positions, for example, coordinates.

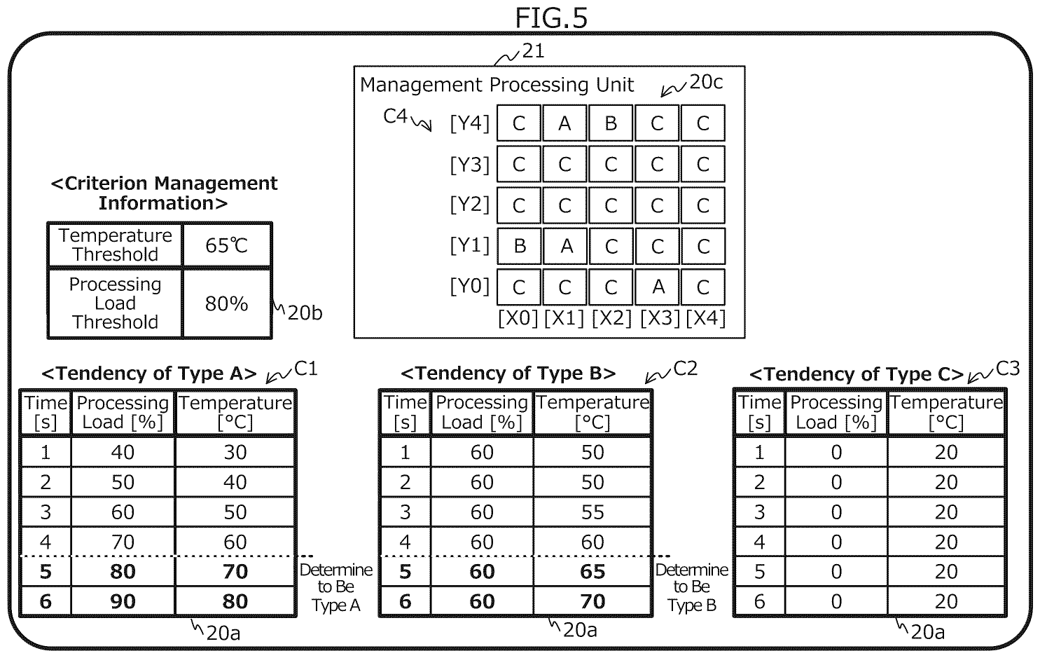

FIG. 5 is a diagram illustrating an example of a method of determining the status of each ACC 5 by the determining unit 21b. The reference signs C1 to C3 correspond to the obtained information 20a of the reference signs B1 to B3 in FIG. 4, respectively. The example of FIG. 5 illustrates a case where the temperature threshold is 65° C. and the processing load threshold is 80%. In relation to an ACC 5 having the obtained information 20a indicated by the reference sign C1 of FIG. 5, the determining unit 21b determines that the ACC 5 is in the type A at the respective time points 5s and 6s at which the operating temperature is equal to or higher than 65° C. and the processing load is equal to or higher than 80%.

Furthermore, in relation to an ACC 5 having the obtained information 20a indicated by the reference sign C2 of FIG. 5, the determining unit 21b determines that the ACC 5 is in the type B at the respective time points 5s and 6s at which the operating temperature is equal to or higher than 65° C. and the processing load is lower than 80%. In relation to an ACC 5 having the obtained information 20a indicated by the reference sign C3 of FIG. 5, the operating temperature is lower than 65° C. and the processing load is lower than 80%. Consequently, the determining unit 21b determines that the ACC 5 is in the type C at all times (at the respective time points is to 6s) at which the obtained information 20a is obtained.

As illustrated in FIG. 5, the determining unit 21b may store, as a status information 20c, the result of classifying each of the multiple ACCs 5 into the memory unit 20 by associating the result with a coordinate C4 representing the position of each of the multiple ACCs 5. The coordinate C4 is an example of the information indicating arrangement of each of the multiple ACCs 5.

The coordinate C4 may be represented, for example, in a one-, two- or three-dimensional array (arrangement) corresponding to the actual (physical) mounting positions of the ACCs 5 in the system 1. In the example of FIG. 5, the arrangement of the ACCs 5 illustrated in FIG. 1 is expressed in a 5×5 two-dimensional array having an X-axis along the alignment of the ACCs 5 in each individual storing casing 3 and a Y-axis across the multiple storing casings 3. In regard to the X-axis direction (X coordinate), the X coordinate value of the ACC 5 the closest to the server 2 is defined as (X0), and the X coordinate value of the ACC 5 the farthest from the server 2 is defined as (X4). In regard to the Y-axis direction (Y coordinate), the Y coordinate value of the storing casing 3 on the bottom row of the drawing is defined as (YC) and the storing casing 3 on the top row of the drawing is defined as (Y4). Hereinafter, a particular coordinate is sometimes represented by the combination of (X coordinate, Y coordinate).

The determining unit 21b determines, based on status information 20c, that the process assigned to an ACC 5 (the first ACC 5 of a migration source) determined to be in the type B among the multiple ACCs 5 is to be migrated to any one of the second ACCs 5 serving as migration destination candidates. FIG. 5 illustrates an example in which the determining unit 21b determines (specifies) the ACC 5 at (XC,Y1) and the ACC 5 at (X2,Y4) as the first ACCs 5 of the migration sources of processes. A first ACC 5 determined to be in the type-B is an example of the first process executing device.

The determining unit 21b may make the above determination, for example, every time the controller 23 obtains the obtained information 20a, such as at given time intervals, on the basis of the latest obtained information 20a. FIG. 5 illustrates an example of the determination made on the basis of the obtained information 20a obtained at the time 6s. Alternatively, the determination by the determining unit 21b may be made at time intervals longer than the given time. In this alternative, the determining unit 21b may make the determination using the results of calculating the averages, weighted averages, or the like of the operation temperatures and the processing loads in the obtained information 20a obtained in the multiple latest times. For example, the weight for each weighted average may be set to have a larger value at a time closer to the present time and a smaller value at a time farther (past) from the present time.

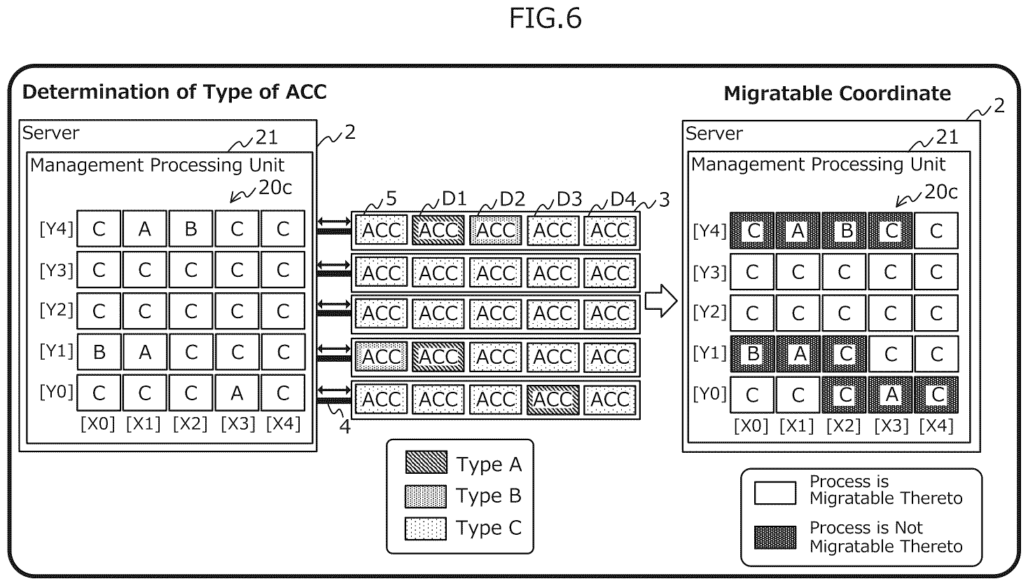

FIG. 6 is a diagram illustrating an example of a method of determining an ACC 5 that is to be a migration destination candidate by the determining unit 21b. After determining the first ACC 5 in the type B to be the migration source, the determining unit 21b may determine (specify) a fourth ACC 5 (hereinafter sometimes referred to as a “migratable card”) that is to be a candidate for a migration destination of the process on the basis of the status information 20c and the obtained information 20a. The fourth ACC 5 that is to be a migration destination candidate is an example of the fourth process executing device.

An example of the migratable card is an ACC 5 that is in the type C and also has an operating temperature lower than the second temperature threshold. The second temperature threshold is an example of the third given value and may be a value equal to or lower than the first temperature threshold. As an example, the second temperature threshold may be a value that can expect the operating temperature to be lower than the first temperature threshold even when the operation temperature of the ACC 5 serving as the migration destination has a raised operation temperature according to increase in the processing load due to the migration of the process. In other words, the second temperature threshold may be smaller by a give margin than the first temperature threshold.

The following description assumes that, for convenience, the given margin is zero, which means that the second temperature threshold equals the first temperature threshold. That is, the following description assumes that an ACC 5 in the type C having an operating temperature lower than the first temperature threshold simultaneously satisfies a condition that the operating temperature is lower than the second temperature threshold. If the given margin exceeds the above-described magnitude, the determining unit 21b may narrow a migration destination candidate ACC 5 or the migration destination ACC 5 on the basis of whether the operation temperature of the ACC 5 is lower than the second temperature threshold.

Further, the determining unit 21b may select, for example, in the determination of a fourth ACC 5 serving as a migration destination candidate, an ACC 5 in the type C not arranged next to a third ACC 5 in the type A and the first ACC 5 in the type B in the line arrangement. The first ACC 5 in the type A is an example of a third process executing device.

For example, if the storing casings 3 are unlikely to be affected by heat generation from each other, the determining unit 21b may specify an ACC 5 arranged not next to the ACC 5 in the type A or the type B in the same storing casing 3 to be a migratable card. As an example, the determining unit 21b determines an ACC 5 in the type C which ACC 5 has the same Y coordinate as an ACC 5 of the type A or B but has an X coordinate not being ±1 of the X coordinates of the ACC 5 of the type A or B to be a migratable card. The determining unit 21b may determine that an ACC 5 of the type C having a Y coordinate on which no ACC 5 in the type A and the type B exists to be a migratable card regardless of the X coordinate.

FIG. 6 illustrates a result of determination of migratability of a process by the determining unit 21b in the status information 20c on the right side of the drawing. An ACC 5 indicated by a hatched frame is an ACC 5 (hereinafter, sometimes referred to as a “non-migratable card”) that is excluded from the migration destination candidates for the process (i.e., an ACC 5 to which the process cannot be moved), and an ACC 5 indicated by the white frame is a migratable card. For example, the ACC 5 indicated by the reference sign D1 in FIG. 6, which is in the type A and is not in the type C, is determined as a non-migratable card. Similarly, the ACC 5 indicated by the reference sign D2, which is in the type B and is not in the type C, is determined as a non-migratable card. Further, the ACC 5 indicated by the reference sign D3 in FIG. 6 is in the type C, but has the coordinate (X3,Y4), which means that the same Y coordinate as the coordinate (X2,Y4) of the ACC 5 in the type B and an X coordinate having a relation of the X coordinate+1 to the coordinate (X2,Y4) of the ACC 5 in the type B. Therefore, the ACC 5 indicated by the reference sign D3 is determined to be a non-migratable card. On the other hand, the ACC 5 of the reference sign D4 in FIG. 6 is in the type C and has a coordinate (X4,Y4). Since the ACC 5 of the reference sign D4 does not have a relationship of an X coordinate ±1 with the ACC 5 in the type A having a coordinate (X1,Y4) and the ACC 5 in the type B having a coordinate (X2,Y4), which however have the same Y coordinate as the ACC 5 of the reference sing D4, the ACC 5 of the reference sign D4 is determined to be a migratable card if having an operating temperature lower than the second temperature threshold.

The determining unit 21b specifies one of the migratable cards determined (specified) in the above-described process to be the second ACC 5 of the migration destination. The second ACC 5 of the migration destination is an example of the second process executing device. As a result, the determining unit 21b can select an ACC 5 unlikely to be affected by a surrounding high-temperature card as a migration destination ACC 5, and consequently can cause multiple ACCs 5 to stably execute processes.

If multiple migration destination candidate ACCs 5 are present, the determining unit 21b may specify the migration destination ACC 5 by various methods. As an example, the determining unit 21b may sequentially specify, as a second ACC 5 serving as a migration destination, an ACC 5 in the ascending or descending order of the X or Y coordinate from among the migratable cards. Alternatively, if multiple migration destination candidate ACCs 5 exist, the determining unit 21b may specify the farthest ACC 5 from the ACCs 5 in the type A and the type B among the migratable cards with reference to the coordinates, and may specify the farthest ACC 5 to the second ACC 5 of the migration destination.

When determining the first ACC 5 in the type B serving as the migration source of a process and the second ACC 5 serving as the migration destination of the process, the determining unit 21b notifies the setting unit 21c of information related to the ACCs 5 of the migration source and the migration destination. The information may include the type of the process to be migrated, and information on the position related to the ACCs 5 of the migration source and the migration destination, such as coordinates of the ACCs 5.

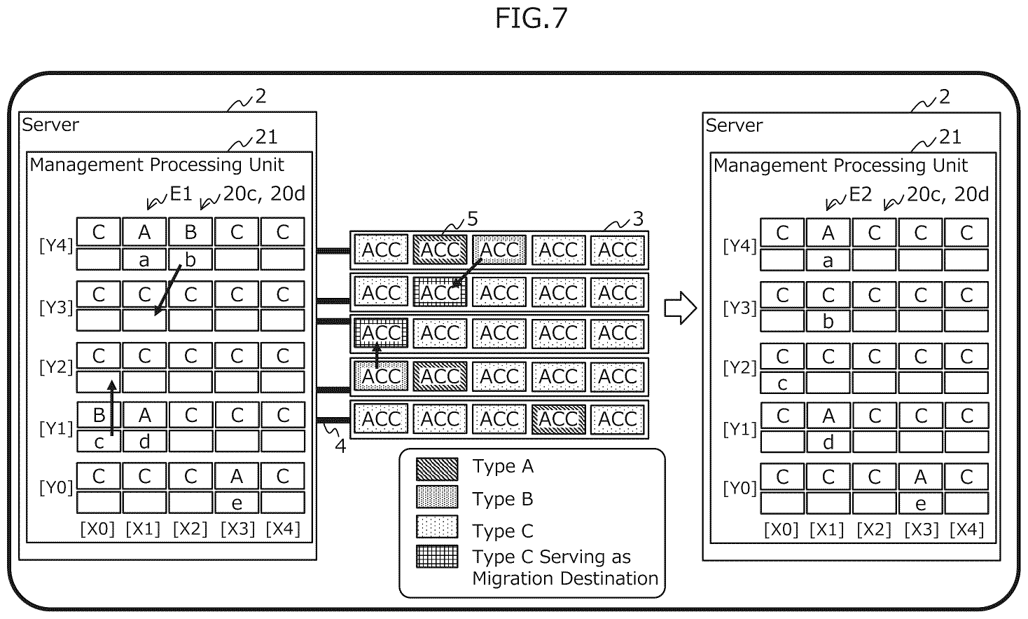

FIG. 7 is a diagram illustrating an example of a method of migrating a process that the setting unit 21c causes an ACC 5 to execute. Upon receipt of notification from the determining unit 21b, the setting unit 21c changes the association between the migration source ACC 5 and the process assigned to the migration source ACC 5 such that the ACC 5 specified to be the migration destination is caused to execute the process that the migration source ACC 5 is caused to execute. Thereby, the setting unit 21c changes the setting of the destination of sending a process request.

As illustrated in FIG. 7, the determining unit 21b may store, into the memory unit 20, as the destination setting information 20d, information related to the transmission destination when the server 2 transmits the process by associating the information with the coordinates representing the respective positions of the multiple ACCs 5.

Like the status information 20c, the coordinates in the destination setting information 20d may be represented, for example, in a one-, two- or three-dimensional array (arrangement) corresponding to the actual (physical) mounting positions of the ACCs 5 in the system 1.

In FIG. 7, the status information 20c and the destination setting information 20d are overlaid for convenience. On the X-Y coordinate illustrated in FIG. 7, the status information 20c is illustrated in the upper row and the destination setting information 20d is illustrated in the lower row in the same coordinate, so that the two pieces of information 20c, 20d are overlaid.

In the destination setting information 20d illustrated in FIG. 7, processes a, b, c, d, and e are assigned to the ACCs 5 at the coordinates (X1,Y4), (X2,Y4), (X0,Y1), (X1,Y1), and (X3,Y0), respectively. In the destination setting information 20d illustrated in FIG. 7, an ACC 5 at a coordinate in which no process is written is an ACC 5 not assigned with a process at the present time, in other words, an ACC 5 not executing any process (idle).

The reference sign E1 in FIG. 7 indicates an example when notification indicating that the process b and the process c are to be migrated is issued from the determining unit 21b to the setting unit 21c. This notification instructs to migrate the process c and the process b being executed in the ACCs 5 of the type B at (X0,Y1) and (X2,Y4) to the ACCs 5 of the migratable cards at (X0,Y2) and (X1,Y3), respectively.

Upon receipt of the notification from the determining unit 21b, the setting unit 21c changes the setting of the transmission destination of a process request by updating the destination setting information 20d. As illustrated in the reference sign E2 of FIG. 7, the setting unit 21c deletes (de-assigns) the process c from the ACC 5 at (X0,Y1) and sets (assigns) the process c to the ACC 5 at (X0,Y2) in the destination setting information 20d. In addition, the setting unit 21c deletes process b from the ACC 5 at (X2,Y4) and sets the process be to the ACC 5 at (X1,Y3). This allows two or more ACCs 5 that are heated due to the dense arrangement to be dispersed in the multiple ACCs 5, for example, in multiple pooled ACCs 5, and can consequently improve the cooling efficiency of the ACCs 5 and can cause the ACCs 5 to stably execute processes.

The transmitting unit 22 transmits, on the basis of the destination setting information 20d, processing requests for various types of processes that the ACCs 5 are to be caused to execute. The transmitting unit 22 may be, for example, an application program that causes the multiple ACCs 5 to execute processes in response to an instruction from the server 2 or a superordinate (upper level) device of the server 2. Examples of the superordinate device include a user terminal or the like of a user who uses the system 1. As an example, the transmitting unit 22 may control the execution of a process such as an analyzing process of big data and an inferring process of AI technique. When the destination setting information 20d is changed by the management processing unit 21, the transmitting unit 22 may switch the ACCs 5 to be transmission destination of the process request based on the changed destination setting information 20d.

### (C) Operating Example

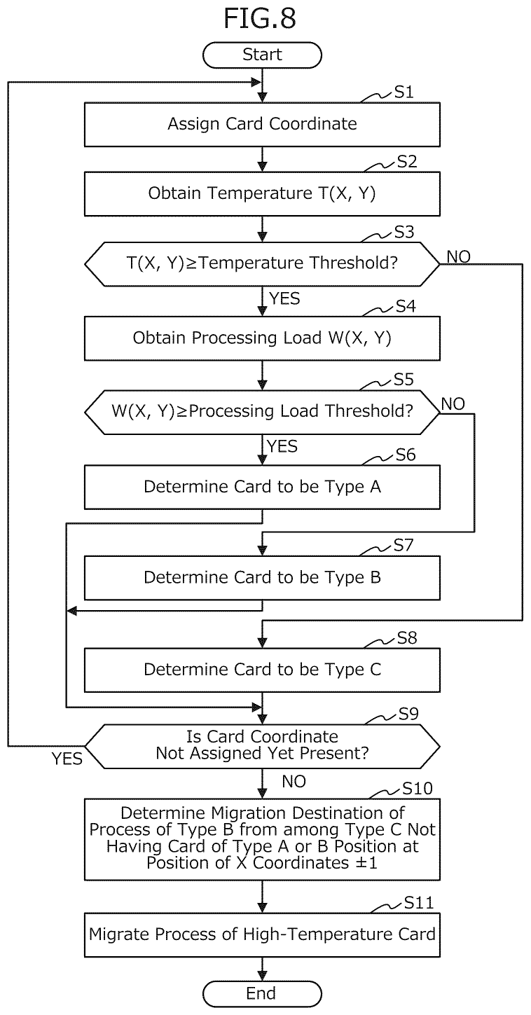

Next, description will now be made in relation to an example of the operation of the system 1 according to the one embodiment. FIG. 8 is a flow chart illustrating an example of operation of the system 1 according to the one embodiment. Hereinafter, description will now be made in relation to an example of the above-described processes performed by the system 1 with reference to the flow chart.

As illustrated in FIG. 8, the obtaining unit 21a of the server 2 assigns the coordinate (X,Y) of the ACC 5 from which the obtained information 20a is to be obtained (Step S1). It is assumed that the server 2 holds in advance the identification information of the usable ACCs 5 and information (for example, coordinates) related to the positions of the ACCs 5. The order of assigning the coordinates in Step S1 may be set in advance, or may be determined on the basis of the identification information or the information about the position. As an example, the coordinates may be assigned by sequentially increasing or decreasing the coordinate values of the X-axis or the Y-axis from the coordinate at which the coordinate values of the X-axis and the Y-axis are the smallest or the largest.

The obtaining unit 21a obtains the temperature T(X,Y) from the ACC 5 at the coordinates assigned in Step S1 (Step S2), and stores the temperature T(X,Y) as the obtained information 20a into the memory unit 20.

The determining unit 21b determines whether or not the obtained temperature T(X,Y) is equal to or higher than the temperature threshold set in the criterion management information 20b (Step S3). If the temperature T(X,Y) is determined to be lower than the first temperature threshold (NO in Step S3), the determining unit 21b determines the ACC 5 at the coordinate (X,Y) to be in the type C (Step S8) and sets the determined type of the ACC 5 in the status information 20c of the memory unit 20.

If the temperature T(X,Y) is determined to be equal to or higher than the first temperature threshold (YES in step S3), the obtaining unit 21a obtains the processing load W(X,Y) from the ACC 5 at the coordinate assigned in Step S1 (Step S4) and sets the obtained processing load W(X,Y) in the obtained information 20a. The obtaining unit 21a may obtain the processing load W(X,Y) along with the temperature T(X,Y) in Step S2.

The determining unit 21b determines whether or not the processing load W(X,Y) is equal to or higher than the processing load threshold set in the criterion management information 20b (Step S5) If the processing load W(X,Y) is determined to be equal to or higher than the processing load threshold (YES in Step S5), the determining unit 21b determines the ACC 5 at the coordinate (X,Y) to be in the type A (Step S6) and sets the determined type of the ACC 5 in the status information 20c of the memory unit 20.

If the processing load W(X,Y) is determined to be lower than the processing load threshold (YES in Step S5), the determining unit 21b determines the ACC 5 at the coordinate (X,Y) to be in the type B (Step S7) and stores the determined type of the ACC 5 into the status information 20c of the memory unit 20.

When the status (type) of the ACC 5 is determined in Step S6, S7 or S8, the determining unit 21b determines whether a card coordinate not assigned yet (undetermined card coordinate) is present (Step S9). If it is determined that a card coordinate not assigned yet is present (YES in Step S9), the process proceeds to Step S1.

As the above, the obtaining unit 21a and determining unit 21b repeat the process of Steps S1 to S9 until all the ACCs 5 that the server 2 can use (e.g., all the ACCs 5 connected to the server 2) are determined to be in any status among the type A, the type B, and the type C.

If it is determined that a card coordinate not assigned yet is not present (NO in Step S9), the determining unit 21b determines the migration destination ACC 5 of the process assigned to an ACC 5 in the type B on the basis of the status information 20c of the multiple ACCs 5 determined in Steps S1 to S9 (Step S10). For example, the determining unit 21b specifies any one of the ACC 5 as the migration destination of the process assigned to the ACC 5 in the type B from among the migration destination candidates (ACCs 5) in the type C having values representing its X coordinate ±1 being the same value as the X coordinates of an ACC 5 the type A or the type B (which means that an ACC 5 arranged to next to the ACC 5 in the type C along the X coordinate is not in the type A or B) and having an operating temperature is lower than the second temperature threshold.

For example, the determining unit 21b notifies the setting unit 21c of information including at least information (for example, identification information) indicating the determined migration destination ACC 5 and the determined migration source (in the type B) ACC 5. On the basis of the notified content, the setting unit 21c changes the settings to migrate the process assigned to the migration source ACC 5 to the migration destination ACC 5 in the destination setting information 20d. As a result, the determining unit 21b migrates the process being executed by the high-temperature card (ACC 5) in the type B (Step S11), and the process ends.

The transmitting unit 22 transmits a process request to the migration destination ACC 5 on the basis of the destination setting information 20d subjected to the change of the setting. As a result, the processing volume in the migration source ACC 5 in the type B is reduced, so that processing load of the ACC 5 is reduced, and a temperature rise in the multiple ACCs 5 including the migration source ACC 5 caused by heat generation of another ACC 5 can be suppressed.

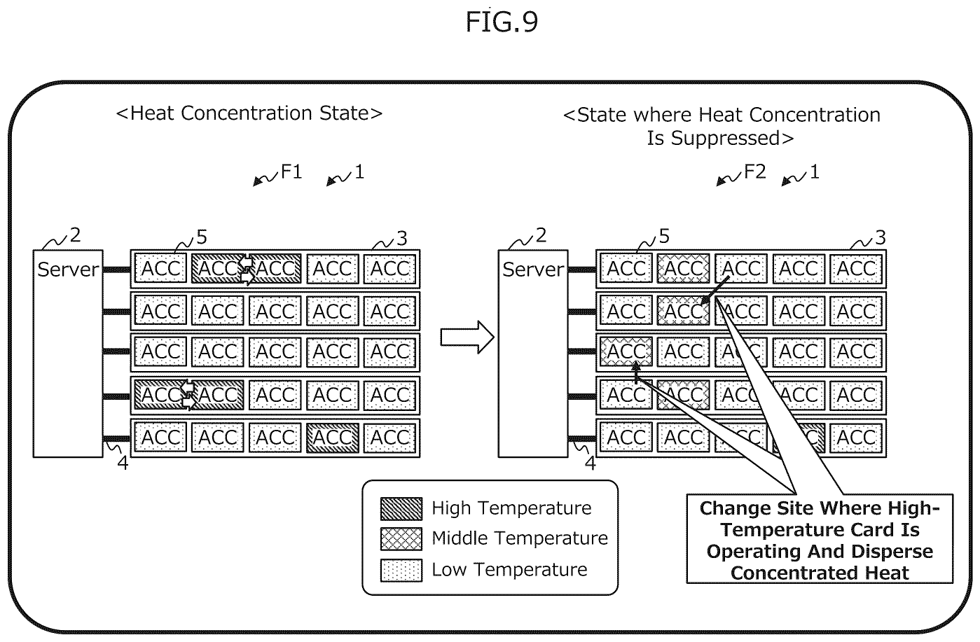

FIG. 9 is a diagram illustrating an example of suppressing heat concentration of multiple ACCs 5 in the one embodiment. In FIG. 9, a block of a high-temperature ACC 5 is illustrated in an oblique-line pattern, a block of a middle-temperature ACC 5 is illustrated in a hatched-line pattern, and a block of a low-temperature ACC 5 is illustrated in a dotted pattern. For example, the high temperature may be equal to or higher than the first temperature threshold, the middle temperature may be lower than the first temperature threshold and equal to or higher than the second temperature threshold, and the low temperature may be lower than the second temperature threshold.

As illustrated in the reference sign F1 of FIG. 9, if ACCs 5 next to each other both have high temperature, the both ACCs 5 has difficulty in heat dissipation due to lowering of the cooling effect and further temperature rise makes each ACC 5 difficult to stably execute the process. As a solution to the above, the above-described process of the one embodiment, as illustrated in the reference sign F2 of FIG. 9 and in FIG. 7, can migrate the process executed by the ACC 5 in the type B heated due to influence from a high-temperature neighboring card to another ACC 5. In the example of FIG. 9, as a result of the migration, the temperatures of four high-temperature ACCs 5 (see reference sign F1) can be declined to the temperatures of three medium-temperature ACCs 5 and the temperatures of one low-temperature ACC 5.

This can switch the position where a high-temperature card is operating, so that the ACC 5 in the type B can be made to have a middle or low temperature and the density of high-temperature cards in multiple ACCs 5 in, for example, a pooled configuration can be abated to disperse and suppress the heat concentration. Accordingly, it is possible to reduce adverse effect that temperature gives to the cooling effects of the ACC 5 in the type B and also the ACC 5 in the type A next to the ACC 5 in the type B to cool themselves and the respective neighboring ACCs 5, and further process executability of the multiple ACCs 5 can be improved.

### (D) Applicable Example

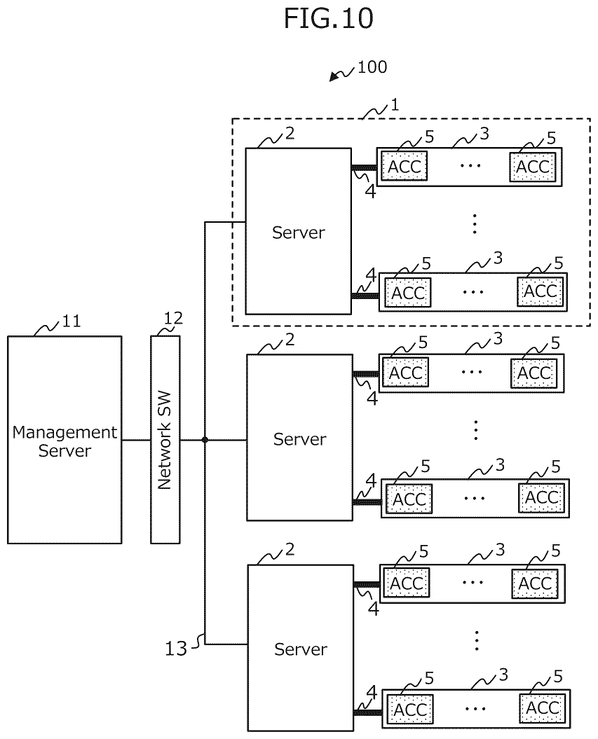

FIG. 10 is a block diagram illustrating an application example of the configuration of the system 1 illustrated in FIG. 1. FIG. 10 focuses on a complex system 100 including multiple systems 1. The complex system 100 may include multiple (three in the example of FIG. 10) systems 1, a management server 11, a network SW (Network Switch) 12, and a network 13. The multiple systems 1 illustrated in FIG. 10 may each include the above-described HW configuration and software configuration.

The complex system 100 is an example of an information processing system that allocates resources in the storing casings 3 to respective servers 2 in the multiple systems 1 and causes the servers 2 or the management server 11 to execute processes using the resources. For example, the complex system 100 may provide a service as the CDI to a user exemplified by a computer that accesses the complex system 100 via a network such as a non-illustrated Internet, using one or more servers 2 and one or more resource pools.

The management server 11 manages the entire complex system 100, for example, manages multiple hardware resources in the complex system 100. For example, the management server 11 may control assignment (allocation) of hardware resources in a resource pool including the ACCs 5 to each of the multiple servers 2 via the network SW 12 and the network 13. The control may flexibly assign hardware resources of the multiple servers 2 and the hardware resources in the multiple resource pools between the multiple systems 1. In the interconnects in the multiple systems 1, a switch may be provided across the multiple systems 1. The switch may communicably connect the multiple servers 2 and the multiple resource pools each including multiple storing casings 3 to one another over the multiple systems 1.

The network SW 12 selectively and communicably connects the management server 11 and each of the multiple servers 2 to each other by switching a connection between the management server 11 and each of the multiple servers 2.

The network 13 communicably connects the management server 11 and the multiple servers 2 to each other via the network SW 12. An example of the network 13 may be, for example, a network including Ethernet® like the above-described interconnect 4. The network 13 may communicably connect the management server 11, each of the multiple servers 2, and each of the multiple resource pools each including the multiple storing casings 3 to one another via the network SW 12.

By the management by the management server 11, each server 2 assigned with a hardware resource including one or more ACCs 5 may execute a process as the transmitting unit 22 in response to a process request transmitted from a user (for example, computer) and reply (transmits) to the user with the execution result.

In addition, the server 2 may execute the process of the above-described management processing unit 21 on the hardware resource including the ACCs 5 assigned thereto. Alternatively, the management server 11 may have, as a software configuration, the function of the management processing unit 21 of the server 2. If the management server 11 has the function of the management processing unit 21, the management server 11 may execute the process performed by the management processing unit 21 described above on the multiple ACCs 5 (hardware resources) connected to one or more servers 2 via the one or more servers 2 or the network 13, for example. For example, the management server 11 may periodically obtain an operating temperature and a processing load of each ACC 5 in the one or more systems 1, determine the migration source and migration destination ACCs 5 of an assigned process, and change the transmission destination of the process request of the process.

Since the management server 11 manages the multiple servers 2 and the multiple ACCs 5, an ACC 5 in a different system 1 from the system 1 including the migration source ACC 5 may be determined to be the migration destination of a process. Accordingly, also when the processing loads of the respective systems 1 are different from each other, a process can be migrated to an ACC 5 in a system 1 having a low processing load. This enables the multiple pooled ACCs 5 to stably execute processes. If the management server 11 has the function of the management processing unit 21, the management processing unit 21 in the one or more servers 2 may be omitted.

### (E) Miscellaneous

The technique according to the above embodiment can be changed and modified as follows.

For example, the functional blocks 20 to 22 included in the server 2 illustrated in FIG. 3 may be merged in any combination or may be divided. The information 20a, 20b, 20c and 20d that the memory unit 20 illustrated in FIG. 3 stores may be merged by any combination or may be divided.

In the description of the one embodiment, the position of each of the multiple ACCs 5 is expressed in a coordinate format, but the expression is not limited thereto. For example, the position of each of the multiple ACCs 5 may be specified by information of the identification number of the ACC 5 or the slot number in the storing casing 3, for example.

In regard to a case where multiple migration destination candidate ACCs 5 exist, the one embodiment describes an example in which an ACC 5 having a large or small X or Y coordinate or an ACC 5 the farthest from the ACCs 5 in the type A or the type B is specified as the migration destination ACC 5. The method of specifying the migration destination ACC 5 from among the multiple migration destination candidate ACCs 5 is not limited to the above. Alternatively, the position of each of the multiple ACCs 5 may be indicated by an index based on the positions of one or more ACCs 5 in the type A, and from among the multiple migration destination candidate ACCs 5, a migration destination ACC 5 may be specified on the basis of the values of indices (e.g., in the ascending or descending order of the ACCs 5). An example of the index may be a numeric value associated with an influence range (e.g., coordinate range) of a temperature rise caused by the heat generation of an ACC 5 in the type A. For example, the index of a certain ACC 5 is a sum of numerical values representing a distance between the certain ACC 5 and each of ACCs 5 in the type A. An example of the numerical value is set to be larger (or smaller) as the certain ACC 5 is closer to each ACC 5 in the type A and be smaller (or larger) as the certain ACC 5 is farther from the ACC in the type A.

In addition, the one embodiment describes a case where ACCs 5 having the same X coordinates in respective different storing casings 3 are not influenced by heat generation of the respective ACCs 5, but is not limited to this case. For example, if ACCs 5 in respective different storing casings 3 may be influence by heat generation of the respective ACCs 5, the determining unit 21b may specify the migration destination ACC 5 by considering the influence of the heat generation. In this case, for example, the determining unit 21b may determine an ACC 5 which can be determined as the migratable card by the above-described determination but which has the same X coordinate as the ACC 5 of the type A or B and a Y coordinate being the Y coordinate ±1 of the ACC 5 of the type A or B to be a non-migratable card. This enables the multiple ACCs 5 to stably execute processes, considering the heat effect between the storing casings 3.

Further, the one embodiment embodies migration of a process between the ACCs 5 among the multiple pooled ACCs 5 serving as the process executing devices connected to the server 2, but the process executing devices are not limited to pooled ACCs 5. Alternatively, the process executing devices connected to the server 2 may be arithmetic processing device such as processors 2a or storage devices such as the memories 2c or the storing devices 2d. For example, if arithmetic processing devices different from the ACCs 5 are pooled, the management processing unit 21 may migrate various processes that the arithmetic processing devices are caused to execute between the arithmetic processing devices, considering heat influence among the arithmetic processing devices. Further, if the storage devices are pooled as the process executing devices, the management processing unit 21 may migrate various processes the storage devices are caused to execute between the storage devices, considering heat influence among the storage devices. Examples of the process to be assigned to the storage devices are a data writing process or a data reading process.

In one aspect, the present embodiment can cause multiple process executing devices to stably execute processes.

Throughout the descriptions, the indefinite article “a” or “an” or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute an information process comprising:
obtaining an operating temperature and a processing load of each of a plurality of process executing devices; and
migrating a process assigned to a first process executing device to a second process executing device, the first process executing device and the second process executing device being included in the plurality of process executing devices, the first process executing device having the operating temperature equal to or higher than a first given value and the processing load lower than a second given value, the second process executing device having the operating temperature lower than a third given value equal to or lower than the first given value.

2. The non-transitory computer-readable recording medium according to claim 1, wherein
the migrating comprises changing an association between the first process executing device and the process assigned to the first process executing device in information that manages assignment of a plurality of the processes to the plurality of process executing devices.

3. The non-transitory computer-readable recording medium according to claim 1, wherein
the plurality of process executing devices are arranged in lines, each of the lines accommodating process executing devices equal to or lower than a given number; and
the migrating comprises selecting the second process executing device from one or more fourth process executing devices, each of the fourth process executing devices not arranged next to a third process executing device and the first process executing device, the third process executing device having the operating temperature equal to or higher than the first given value and the processing load equal to or higher than the second given value.

4. The non-transitory computer-readable recording medium according to claim 3, wherein
the plurality of process executing devices is accommodated in a plurality of casings, each of the plurality of casings capable of accommodating two or more process executing devices in lines; and
the migrating comprises specifying the fourth process executing devices not arranged next to the third process executing device and the first process executing device in a same one of the plurality of casings.

5. The non-transitory computer-readable recording medium according to claim 3, wherein
the selecting comprises specifying the fourth process executing devices based on the obtained operating temperature and the obtained processing load of each of the plurality of process executing devices and information indicating arrangement of each of the plurality of process executing devices.

6. The non-transitory computer-readable recording medium according to claim 3, wherein
the selecting comprises selecting the second process executing device having the operating temperature lower than the third given value and the processing load lower than the second given value.

7. A computer-implemented method for processing information comprising:
obtaining an operating temperature and a processing load of each of a plurality of process executing devices; and
migrating a process assigned to a first process executing device to a second process executing device, the first process executing device and the second process executing device being included in the plurality of process executing devices, the first process executing device having the operating temperature equal to or higher than a first given value and the processing load lower than a second given value, the second process executing device having the operating temperature lower than a third given value equal to or lower than the first given value.

8. The computer-implemented method according to claim 7, wherein
the migrating comprises changing an association between the first process executing device and the process assigned to the first process executing device in information that manages assignment of a plurality of the processes to the plurality of process executing devices.

9. The computer-implemented method according to claim 7, wherein
the plurality of process executing devices are arranged in lines, each of the lines accommodating process executing devices equal to or lower than a given number; and
the migrating comprises selecting the second process executing device from one or more fourth process executing devices, each of the fourth process executing devices not arranged next to a third process executing device and the first process executing device, the third process executing device having the operating temperature equal to or higher than the first given value and the processing load equal to or higher than the second given value.

10. The computer-implemented method according to claim 9, wherein
the plurality of process executing devices is accommodated in a plurality of casings, each of the plurality of casings capable of accommodating two or more process executing devices in lines; and
the migrating comprises specifying the fourth process executing devices not arranged next to the third process executing device and the first process executing device in a same one of the plurality of casings.

11. The computer-implemented method according to claim 9, wherein
the selecting comprises specifying the fourth process executing devices based on the obtained operating temperature and the obtained processing load of each of the plurality of process executing devices and information indicating arrangement of each of the plurality of process executing devices.

12. The computer-implemented method according to claim 9, wherein
the selecting comprises selecting the second process executing device having the operating temperature lower than the third given value and the processing load lower than the second given value.

13. An information processing device comprising:
a memory; and
a processor coupled to the memory, the processor being configured to execute an information process comprising
obtaining an operating temperature and a processing load of each of a plurality of process executing devices; and
migrating a process assigned to a first process executing device to a second process executing device, the first process executing device and the second process executing device being included in the plurality of process executing devices, the first process executing device having the operating temperature equal to or higher than a first given value and the processing load lower than a second given value, the second process executing device having the operating temperature lower than a third given value equal to or lower than the first given value.

14. The information processing device according to claim 13, wherein
the migrating comprises changing an association between the first process executing device and the process assigned to the first process executing device in information that manages assignment of a plurality of the processes to the plurality of process executing devices.

15. The information processing device according to claim 13, wherein
the plurality of process executing devices are arranged in lines, each of the lines accommodating process executing devices equal to or lower than a given number; and
the migrating comprises selecting the second process executing device from one or more fourth process executing devices, each of the fourth process executing devices not arranged next to a third process executing device and the first process executing device, the third process executing device having the operating temperature equal to or higher than the first given value and the processing load equal to or higher than the second given value.

16. The information processing device according to claim 15, wherein
the plurality of process executing devices is accommodated in a plurality of casings, each of the plurality of casings capable of accommodating two or more process executing devices in lines; and
the migrating comprises specifying the fourth process executing devices not arranged next to the third process executing device and the first process executing device in a same one of the plurality of casings.

17. The information processing device according to claim 15, wherein
the selecting specifying the fourth process executing devices based on the obtained operating temperature and the obtained processing load of each of the plurality of process executing devices and information indicating arrangement of each of the plurality of process executing devices.

18. The information processing device according to claim 15, wherein
the selecting comprising selecting the second process executing device having the operating temperature lower than the third given value and the processing load lower than the second given value.
